(19) United States
(12) Patent Application Publication
(10) Pub. No.: US 2004/0040160 A1
(43) Pub. Date: Mar. 4, 2004

(54) Food handling kitchen utensils

(76) Inventors: Milton L. Cohen, Hewlett Bay Park, NY (US); Jeff Siegel, Center Island, NY (US); Adam Krent, Brooklyn, NY (US)

Correspondence Address: PERRY TEITELBAUM, GOODMAN & TEITELBAUM, SUITE 1400, 26 COURT STREET, BROOKLYN, NY, 11242, US

(21) Appl. No.: 10/228,378

(22) Filed: Aug. 27, 2002

(51) Int. Cl. B26B 3/00

(52) U.S. Cl. 30/169

(57) ABSTRACT

A food handling utensil is comprised of a handle configured to be gripped by the hand of a user. The food-contacting part is connected to the handle by an elongate neck portion. The food-contacting part is formed of a non-rigid heat-resistant material that resists being damaged when placed in contact with a surface of a receptacle exposed to a direct flame and containing food being prepared. Reinforcement means encapsulated within selected portions of the food-contacting part to enhance stiffness in selected portions of the utensil while the remaining portions of the food-contacting part continue to exhibit the flexibility of the heat-resistant material.

### BACKGROUND OF THE INVENTION

1. Field of the Invention

The invention generally relates to kitchen tools and, more particularly, to food-handling utensils that have a capacity for withstanding high temperatures while providing desirable mechanical properties such as desired flexibility and rigidity in different portions of the tool.

2. Description of the Prior Art

Food-handling utensils or tools used in the kitchen come in different forms. Spatulas, spoons, ladles—whether solid or perforated—perform various functions dealing with the handling of food.

Early kitchen tools were typically formed with wooden handles and metal work ends. In this way, the work ends, which were typically exposed to higher temperatures, such as in the turning of a hamburger or flipping of an egg in a skillet, could withstand the high temperatures. The wooden handles served to insulate the metal portions of the utensils to prevent excessive heat from coming into contact with the hand of the user. However, such tools had disadvantages. First, after repeated use the connection between the shank and the handle or work-end frequently became loose, causing the tool to fail. Additionally, the metal work ends were frequently sharp or abrasive and could scratch or scrape the surfaces on which the food was being prepared, such as a skillet, frying pan, etc. This became an even greater problem with the advent of Teflon-coated products applied to frying pans and the like to prevent the food from sticking. The metal work end frequently scratched or otherwise damaged such Teflon-coatings and, with time, defeated the purpose or function of the Teflon coated product.

In recent years, plastics have become widely used in the manufacture of kitchen tools or utensils. Such tools have frequently been made with a plastic handle. Nylon, other plastics and Teflon-coated products were also used to form the work-end sections.

Ideally, a kitchen tool or utensil that is used to process foods that are being heated should be able to withstand high temperatures. Such tools also need to be easy to clean, and the materials must be sufficiently stable to avoid migration of any of the material from the work end to the food being handled. Other desirable properties are that the materials used must be able to resist staining and discoloration, and should be microwave usable. Naturally, the handle end must stay cool enough so that the appliance can be used even when the work end is exposed to temperatures in excess of 400° F.

U.S. Pat. Nos. 4,937,942 and 5,014,434 disclose a kitchen tool that is integrally formed in one piece and designed to withstand high temperatures and facilitate microwave use. The disclosed tools, which include a solid and slotted spatula as well as a slotted spoon, are made by injection molding using a polyetheramide sold by General Electric under the trademark “ULTEM.” The entire kitchen tool is integrally formed in a single piece construction including the handle end, work end and the shank or neck of the tool. However, “ULTEM” is a relatively rigid material. Therefore, in order to satisfy the requirements of temperature resistance and ability to operate in a microwave environment, the entire tool is formed of a substantially rigid material that lacks the flexibility or resilience frequently desired to be exhibited in at least selected portions of the tools. Also, because “ULTEM” is a relatively expensive thermoplastic material, its use for making the work end of the tools or utensils is not normally cost-justified. Certainly, to produce the entire tool, including the handle and neck, of this material renders any resulting product much too costly for most applications or uses.

In U.S. Pat. No. 5,376,325, a kitchen tool and method of its manufacture are disclosed. The kitchen tool has a work end made of a molded plastic materials which is then molded to a reinforced plastic handle. However, the reinforcement in the plastic handle only extends to the shank or neck of the utensil and the work end of the utensil is not reinforced. Therefore, either such end is too rigid or stiff throughout, if the plastic material used for the work end is a rigid one, or the work end is too soft throughout, if the plastic material used for that portion of the tool exhibits significant flexibility or softness.

### SUMMARY OF THE INVENTION

In order to provide an improved kitchen utensil for handling food products, particularly for use in a hot temperature environment, it is an object of the present invention to provide such kitchen utensil which does not have the disadvantages inherent in comparable kitchen utensils.

It is another object of the present invention to provide a kitchen utensil that has the desired performance characteristics, particularly making the food contacting part of such utensil highly heat-resistant.

It is still another object of the invention to provide a kitchen utensil that is simple in construction and economical to manufacture.

It is yet another object of the invention to provide a kitchen utensil as in the above objects which both is both practical and aesthetic.

It is a further object of the invention to provide a kitchen utensil of the type under discussion that will maintain its physical properties over extended periods of use, including not becoming discolored after repeated contact with food.

It is still a further object of the present invention to provide a kitchen utensil that is formed of a non-rigid heat-resistant material that is suitably reinforced in parts to stiffen selected or desired portions of the food contacting parts while maintaining remaining portions, notably the edges thereof, more flexible to conform to various food processing containers or receptacles.

It is yet a further object of the invention to provide a kitchen utensil in which the food contacting part is made from a firm but flexible rubber-like material, such as silicone rubber, which is resistant to high temperatures and unaffected by microwave radiation while being safe for use in connection with the processing of food.

In order to achieve the above objects, as well as other which will become evident hereinafter, a food handling utensil in accordance with the present invention comprises a handle configured to be gripped by the hand of a user. A food contacting part is connected to said handle by means of a elongate neck portion, said food contacting part being formed of a non-rigid heat-resistant material that resists being damaged when placed in contact with the surface of a receptacle exposed to a direct flame and containing food being prepared. Reinforcement means is provided that is encapsulated within selected portions of said food contacting part to enhance the stiffness in said selected portions while the remaining portions of said food contacting part continue to exhibit the flexibility of said heat-resistant material. A preferred non-rigid heat-resistant material for use in connection with the present invention is silicone rubber.

### BRIEF DESCRIPTION OF THE DRAWINGS

With the above and additional objects and advantages in view, as will hereinafter appear, this invention comprises the devices, combinations and arrangements of the parts hereinafter described by way of example and illustrated in the accompany drawings of the preferred embodiments, in which:

FIG. 1 is a perspective view of a prior art kitchen utensil, particularly a turner or spatula;

FIG. 2 is a perspective view of a silicone rubber coated plastic kitchen tool in the form of a turner or spatula, in accordance with the present invention;

FIG. 3 is a fragmented top view of the turner shown in FIG. 2;

FIG. 4 is a sectional view along line 4-4 of FIG. 3;

FIG. 5 is a sectional view along line 5-5 of FIG. 3;

FIG. 6 is a sectional view along line 6-6 of FIG. 3;

FIG. 7 is a fragmented bottom view of the turner of FIG. 2;

FIG. 8 is a fragmented left side view of FIG. 2;

FIG. 9 is a fragmented right side view of FIG. 2;

FIG. 10 is a fragmented front view of FIG. 2;

FIG. 11 is a fragmented rear view of FIG. 2;

FIG. 12 is similar to FIG. 2, but showing a slotted spatula according to the invention;

FIG. 13 is a sectional view of the spatula shown in FIG. 12;

FIG. 14 is a perspective view of a prior art spoon;

FIG. 15 is a perspective view of a silicone rubber coated plastic kitchen tool in the form of a spoon, in accordance with the present invention;

FIG. 16 is similar to FIG. 15, but showing a slotted spoon according to the invention; and

FIG. 17 Is a sectional view of the spoon shown in FIG. 16, taken along 17-17.

### DESCRIPTION OF THE PREFERRED EMBODIMENTS

Referring now more specifically to the figures, in which identical or similar parts are designated by the same reference numerals throughout, and first referring to FIG. 1, a prior art spatula or turner is generally designated by the reference numeral 10.

The spatula 10 includes a handle 12 configured to be gripped by the hand of a user. A food contacting part 14 is connected to the handle 12 by means of an elongate neck portion or shank 16. A common form of spatula is provided with a plurality of spaced elongate cut-outs or slots 18, as shown, that generally extend in a direction parallel to the length direction or axis of the utensil. In a spatula provided with such slots 18, the food contacting part 14 is provided with a proximate portion 14a connected to the neck portion 16 and distal portion 14b. Longitudinal portions 14c-14g extend from the proximate portion 14a to the distal portion 14b. Typically, in the prior art spatulas, the neck portion 16 and the food contacting portion 14 are made of a stamped sheet metal part suitably secured to a heat-resistant handle 12, made of wood, plastic or the like. Typically, the food contacting part 14, the neck portion 16 and, in some instances, even the handle 12 are all made of a suitable plastic material such as the “ULTEM” plastic discussed previously in connection with U.S. Pat. Nos. 4,937,942 and 5,014,434. In some instances, where the food contacting portion 14 is made of metal, such as stainless steel, it is provided with a relatively thin coating, such as TEFLON, intended to avoid sticking of food to the implement or utensil.

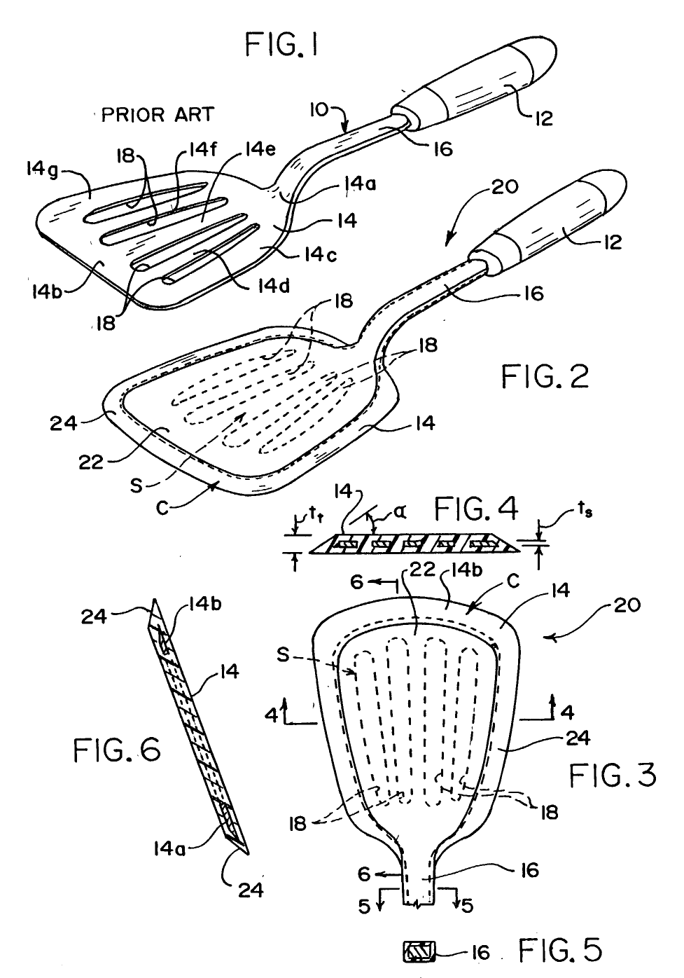

Referring to FIGS. 2-5, a food handling kitchen utensil in accordance with the present invention is generally designated by the reference numeral 20. As in the prior art spatula of FIG. 1, the utensil 20 likewise has a handle 12, a food contacting part 14 and a neck portion 16 extending between and connecting the two. An important feature of the present invention is that the food contacting part 14 is formed of a non-rigid heat-resistant material that resists being damaged when placed in contact with the surface of a receptacle exposed to a direct flame and containing food being processed. A suitable reinforcement member, in the form of a skeleton S, shown in dashed outline in FIGS. 2 and 5, enhance the stiffness in the selected portions of the food contacting part while the remaining portions of the food contacting part continue to exhibit the flexibility of the heat-resistant material. In this connection, the skeleton S embedded or encapsulated within the heat-resistant material forming a cover C. The skeleton S may, for example, have the same or similar appearance as the food contacting part 14 shown in FIG. 1. The skeleton S can be formed of metal, such as steel, or any suitable plastic material. The skeleton should be formed of a material that is stiffer than the material forming the food contacting part cover C so that the remaining portions, which are not selectively stiffened or reinforced by the skeleton, remain relatively soft and pliable or flexible to conform to the shape or surface on which the food is being processed without scratching or damaging such surface.

It will be clear that the present invention can be used with numerous kitchen utensils that incorporate various food contacting parts having different shapes and functions. In FIG. 2 the food contacting part is in the shape of a flat spatula or turner. In FIGS. 12-16 such kitchen utensil is shown to be in the form of a spoon, scooper or skimmer.

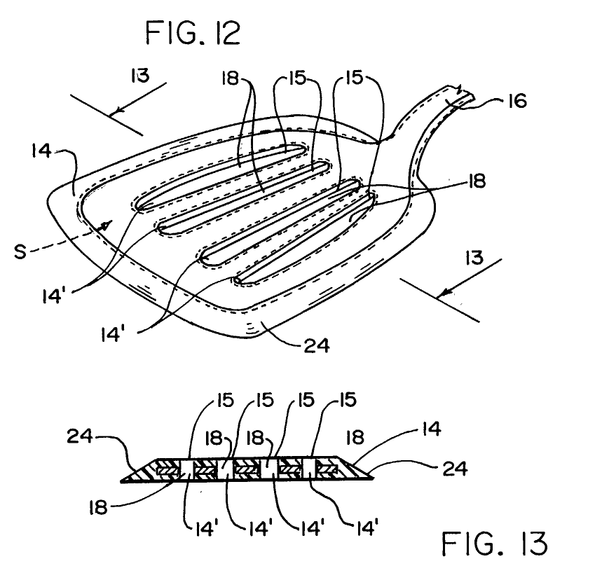

The skeleton or reinforcement member S may be provided with apertures, such as spaced elongate slots, similar to those shown in the prior art spatula of FIG. 1. These slots are shown in phantom outline in FIGS. 2 and 5, and better shown in the cross sections in FIGS. 4 and 6. When provided with such apertures or elongate slots, the flexibility or stiffness of the skeleton or reinforcement member S can be modified or adjusted. The food contacting part 14 may also be provided with apertures 14′, as shown in FIGS. 12, 13, that generally align with the apertures or elongate slots 18 in the reinforcement member or skeleton S to provide through apertures 15 in the food contacting part 14.

An important feature of the invention is that the non-rigid heat-resistant material in accordance with the invention is a silicone rubber. Thus, while “ULTEM”, previously proposed to be used in connection with some prior art kitchen utensils, is heat-resistant up to approximately 400°-430° F., and is essentially rigid so that it could not bend or flex, silicone rubber has a number of characteristics and advantages not inherent in conventional materials, including “ULTEM.” Thus, silicone rubber can easily be formulated so that even general purpose silicone rubbers can resist temperatures upwards of 450° F. General purpose silicone rubbers typical resist temperatures of 450°-500° F. However, by adding additives, silicone rubbers may be made heat resistant and durable at higher temperatures extending up to 600° F.

Silicone rubber is generally inert, odorless, tasteless and stainless. Therefore, it is ideal for food applications. It has high resistance to weathering and oxidation, and superior resistance to many chemicals so that it is very suitable for use in connection with the processing of various food products. Silicone rubber has very good thermal resistance and special flame retardant compounds are available. This assures that the handle 12 is protected from exposure to high temperatures—a frequent failure of some handles and, of course, potential injury to the user. It has superior water resistance so that it exhibits low water absorption. Silicone rubber can be extruded and it lends itself readily to the molding of various parts, including intricate molded parts. Silicone rubber can also be adhered to metal and plastic parts so that it is ideal for bonding and encapsulation of stiffening materials as in accordance with the present invention. There are wide ranges of heat cured silicone rubbers that can be used for general molding of products and are excellent in a wide range of uses. Food use is one of such uses. As indicated, numerous silicone rubber compounds are flame resistant and provide good heat resistance. Silicone rubbers are available from numerous suppliers including General Electric and Wacker Silicones. Specific product numbers and types suitable for use for the purposes described herein will be known or readily evident to those skilled in the art, depending on the specific applications or characteristics that are desired for the utensils.

As is best shown in FIG. 4, for example, the non-rigid heat-resistant material forming the food contacting part 14 encapsulates the reinforcement means or skeleton S and, as shown in FIG. 2, also encapsulates at least a part of the neck portion 16. Thus, with the exception of the handle 12, the entire tool is formed or coated with the heat-resistant material to provide a uniform, aesthetic appearance. Also, by extending the heat-resistant material beyond the food contacting part 14 to also cover the neck portion 16, food traps are avoided that may be difficult to clean, as a continuous smooth surface is exhibited by the encapsulating material.

As will evident, for example, from FIGS. 2-4, 6, 13-15 and 17, the reinforcement member or skeleton S generally has the shape of the food contacting part 14 but is slightly undersized so that the skeleton preferably defines a periphery that generally follows and is spaced inwardly from a periphery of the food contacting part. This renders the peripheral edge of the utensil unreinforced and, therefore, more flexible. In the case of the spatula 20, the unreinforced peripheral edge remains relatively flexible so that it can conveniently conform to the shape of the container in which the food is being processed. To increase such flexibility even further and to facilitate insertion of the spatula below food being processed, the peripheral unreinforced edge is preferably provided with a taper 24. The taper, referring to FIG. 4, can exhibit an angle a which can advantageously be selected from the range of 20°-30°. The specific value of a is not, however, critical for the purposes of the present invention.

The skeleton or reinforcement member S may be formed of a metal or of a plastic material that is stiffer or less flexible than the heat-resistant material that encapsulates the stiffening member.

Referring to FIG. 4, the cross-sectional dimensions of the utensil are not critical. In the case of the spatula 20, the total thickness tᵢ may conveniently be selected from the range of 4-6 mm. The food contacting part 14 may also be slightly tapered in the direction from the neck portion 16 to the distal portion 22 in order to increase flexibility at the distal end relative to the proximate end closer to the neck portion 16.

Where the thickness of the reinforcement member or skeleton is tₛ, the ratio tₜ/tₛ may be in the approximate range of 2-3. As is best shown in FIG. 4, the heat-resistant material has thicknesses above and below the skeleton or reinforcement member S, that are substantially equal. Therefore, the total thickness of the heat-resistant material tₘ=tₜ−tₛ. Where the layer of the heat-resistant material above and below the reinforcement means is approximately equal to (tₜ−tₛ)/2 mm. In a presently preferred embodiment, the thickness of the heat-resistant material above and below the reinforcement member or skeleton is approximately equal to 1.5 mm.

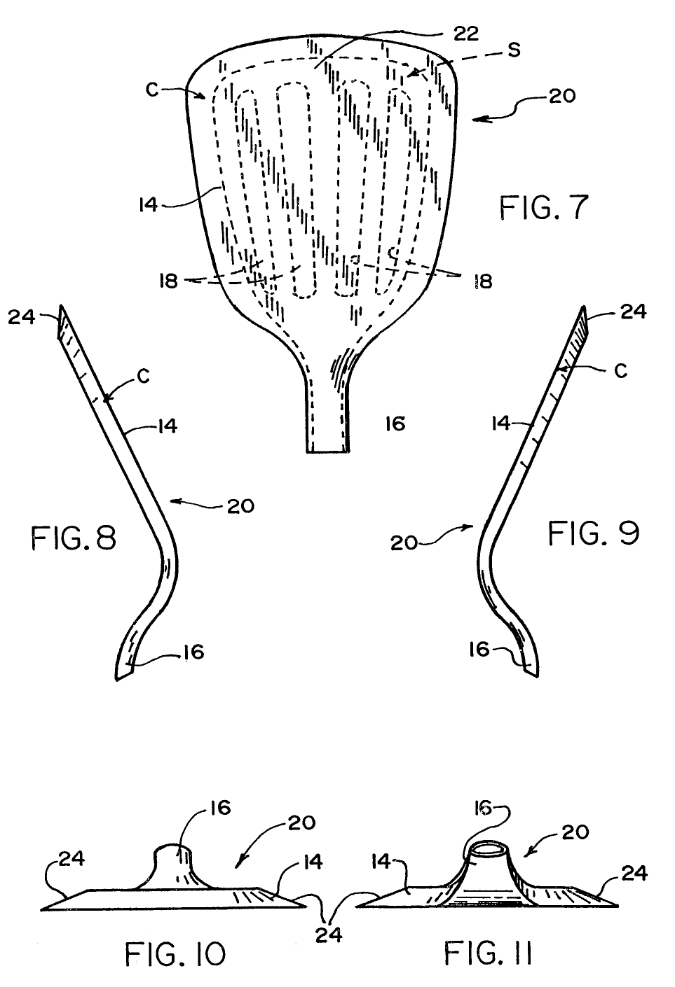

In FIG. 7, the silicone rubber cover C is illustrated, with the position of the skeleton S being shown in phantom outline. As indicated in connection with FIGS. 12, 13, the elongate slots 18 in the skeletons may also optionally be provided, at 14′, within the silicone rubber cover C so that such openings or elongate slots are aligned with each other to provide through slots 15 that extend through the entire utensil. In that event the silicone rubber cover C needs to be molded completely around the longitudinal portions 14c-14g of the reinforcement member, including the regions extending through the slots as shown in FIG. 13, so that food traps are avoided. FIGS. 8-11 illustrate the various views of the skeleton S which is suitable for insertion and/or encapsulation within a silicone rubber cover C.

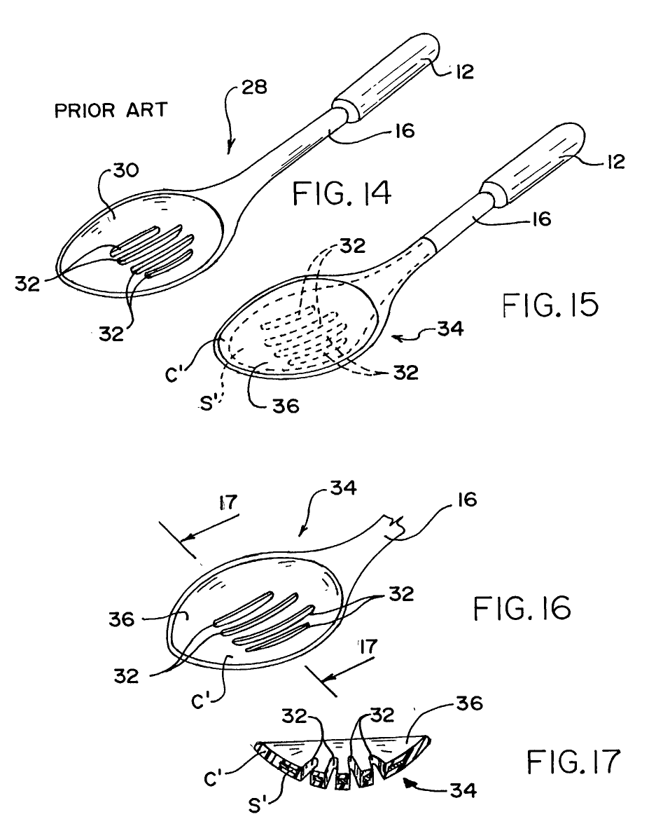

In FIG. 14, a prior art slotted spoon kitchen utensil 28 is shown. As with the prior art spatula 10, the same or comparable configuration of the food contacting part 30 may be used as a skeleton or a stiffening member that can be encapsulated within a silicone rubber cover C′ (FIG. 15). Therefore, the spoon kitchen utensil 34, as shown in FIGS. 15-17, has the same or similar construction as the spatula of FIGS. 2-5, with the exception of the shape and functionality of the food contacting part 36. As with the spatula, the reinforcement member or skeleton S′ can be slotted, if desired. Similarly, the silicone rubber cover C′ may itself be provided with slots, as shown in FIGS. 16 and 17, that are aligned with the slots 32 in the reinforcement member or skeleton S′ to provide a slotted spoon 34. Again, the silicone rubber coating or cover C′ would need to fully encapsulate the skeleton or reinforcement member to avoid food traps, as shown in FIG. 17.

The use of silicone rubber for kitchen utensils exposed to heat has, for the reasons aforementioned, advantages which are not provided by other materials commonly used for such utensils, including plastic, NYLON, TEFLON and other plastics including “ULTEM.” Silicone rubber's heat resistance is at least 500° F. and can be formulated to resist even higher temperatures. However, because silicone rubber without a skeleton support is too soft or flexible to be used as a kitchen utensil, the use of a reinforcement member or skeleton to stiffen selected parts of the tool results in a kitchen utensil that has the requisite stiffness where it is needed and yet provides flexibility where that may be desirable, such as about the periphery of a spatula, by not reinforcing such periphery.

Silicone rubbers have a number of advantages, discussed above, and also exhibit nonstick properties so that food will not stick to the tools. Because of its softness and resistance to heat, silicone rubber is also safe to use on all cookware surfaces, including all nonstick surfaces. It will not cause any scratches on the surface of cookware. Also, silicone rubbers can be made to be quite stable and are suitable for use in connection with food, and can be safely used therewith, as numerous silicone rubbers have been approved by the Food and Drug Administration for such purposes.

While this invention has been described in detail with particular reference to preferred embodiments thereof, it will be understood that variations and modifications will be effected within the spirit and scope of the invention as described herein and as defined in the appended claims.

What is claimed:

1. A food handling utensil comprising a handle configured to be gripped by the hand of a user;
a food contacting part connected to said handle by means of an elongate neck portion, said food contacting part being formed of a non-rigid heat-resistant material that resists being damaged when placed in contact with a surface of a receptacle exposed to a direct flame and containing food being prepared;
and reinforcement means encapsulated within selected portions of said food contacting part to enhance stiffness in said selected portions while the remaining portions of said food contacting part continue to exhibit the flexibility of said heat resistant material.

2. A utensil as defined in claim 1, wherein said food contacting part is configured as a spoon.

3. A utensil as defined in claim 2, wherein said spoon is provided with apertures.

4. A utensil as defined in claim 3, wherein said apertures are spaced elongate slots.

5. A utensil as defined in claim 1, wherein said food contacting part is configured as a spatula.

6. A utensil as defined in claim 5, wherein said spatula is provided with apertures.

7. A utensil as defined in claim 6, wherein said apertures are spaced elongate slots.

8. A utensil as defined in claim 1, wherein said non-rigid heat resistant material is silicone rubber.

9. A utensil as defined in claim 1, wherein said non-rigid heat resistant material encapsulates said food contacting part and at least part of said neck portion.

10. A utensil as defined in claim 1, wherein said reinforcement means comprises a skeleton generally having the shape of said food contacting part and being slightly undersized so that said skeleton defines a periphery that generally follows and is spaced inwardly from a periphery of said food contacting part.

11. A utensil as defined in claim 10, wherein said skeleton is formed of metal.

12. A utensil as defined in claim 10, wherein said skeleton is formed of a plastic material that is stiffer or less flexible than said heat-resistant material.

13. A utensil as defined in claim 10, wherein said heat-resistant material is molded to fully encapsulate said skeleton.

14. A utensil as defined in claim 10, wherein said skeleton is provided with apertures the size of which modify the stiffness of said skeletons and thereby said food contacting part.

15. A utensil as defined in claim 14, wherein said food contacting part is provided with apertures generally aligned with said apertures in said skeleton to provide through apertures in said food contacting part.

16. A utensil as defined in claim 1, wherein said reinforcement means has a thickness tₛ and the ratio tₜ/tₛ is in the approximate range of 2-3.

17. A utensil as defined in claim 16, wherein said heat-resistant material has substantially equal thicknesses above and below said skeleton.

18. A utensil as defined in claim 16, wherein said heat-resistant material has a thickness tₘ=tₜ−tₛ.

19. A utensil as defined in claim 17, wherein the layer of heat-resistant material above and below said reinforcement means is approximately equal to (tₜ−tₛ)/2.

20. A utensil as defined in claim 18, wherein (tₜ−tₛ)/2 is equal to approximately 1.5 mm.

21. A utensil as defined in claim 1, wherein said heat-resistant material comprises a grade of silicone rubber formulated to resist temperatures about 450° F.
